(19) United States
(12) Patent Application Publication
(10) Pub. No.: US 2017/0060356 A1
(43) Pub. Date: Mar. 2, 2017

(54) NUMERICAL CONTROLLER WITH MENU

(71) Applicant: FANUC CORPORATION, Yamanashi (JP)

(72) Inventors: Rie Oota, Yamanashi (JP); Mamoru Kubo, Yamanashi (JP)

(73) Assignee: FANUC CORPORATION, Yamanashi (JP)

(21) Appl. No.: 15/233,164

(22) Filed: Aug. 10, 2016

(30) Foreign Application Priority Data
Aug. 27, 2015 (JP) 2015-168105

(51) Int. Cl. G06F 3/0482; G06N 99/00

(52) U.S. Cl. CPC G06F 3/0482; G06N 99/005; G05B 2219/31264; G05B 2219/36089; G06F 3/04817

(57) ABSTRACT

A numerical controller acquires state data including information indicating a machining state and information indicating a selected menu item, creates a machine learning model for determining a menu item display order in menu display based on the state data, and determines a menu item display order in the menu display based on the created machine learning model and the state data.

### BACKGROUND OF THE INVENTION

1. Field of the Invention

The present invention relates to a numerical controller, and particularly to a numerical controller having a function which displays a menu in an appropriate display order according to a machining process and a machining state.

2. Description of the Related Art

In recent years, applications for assisting machining as a whole have often been incorporated into a numerical controller in addition to essential functions. Accordingly, menu display has been introduced for easy access to each application. Generally, a menu screen is designed in consideration of user friendliness so that menu items likely to be frequently used by a user may be located at easy-to-access positions.

As a prior art technique relating to menu display, Japanese Patent Application Laid-Open No. 2009-181501 discloses a mobile communication device having a menu screen in which functional icons are arranged as cells in the form of a matrix, wherein the icons are rearranged according to the number of uses of each functional icon in order of the degree of priority which is set for each cell on the menu screen and which is the order of priority of functional icons to be arranged, and a more user-friendly menu screen is displayed.

Moreover, Japanese Patent Application Laid-Open No. 2010-127814 discloses a technique of displaying menu, wherein information on the current state of a navigation device is acquired as parameters such as the current time, the day of the week, travel time, the number of riding persons, and weather when a menu is displayed, a table specifying the order of display items of a menu corresponding to these parameters is stored in memory, a menu display item order is found based on the acquired parameters, and a menu arranged in the menu display item order is displayed.

In menu display, in the case where the number of applications is large, access to a frequently used application may become difficult. Accordingly, in the technique described in the aforementioned Japanese Patent Application Laid-Open No. 2009-181501, a menu is arranged according to the number of uses of each icon, and, in the technique described in Japanese Patent Application Laid-Open No. 2010-127814, a menu is arranged according to a table including current states as parameters. Thus, a user-friendly menu screen is displayed.

However, in machine tools in which a different application is used depending on a machining process, a machining state, status, and the like, an occasional but important manipulation may disappear from a menu if the menu is simply arranged according to the number of uses or the like. For example, in the case where applications for machining are frequently used, applications for maintenance may disappear from the menu, and access to applications for maintenance may become difficult when maintenance is to be performed.

Moreover, in the technique described in the aforementioned Japanese Patent Application Laid-Open No. 2010-127814, a menu depending on the state is displayed by preparing a table for specifying a menu display item order from parameters in advance. However, since such a table could not dynamically deal with a change from an expected state, the table needs to be newly manually re-created according to each change in the state. Moreover, if the number of parameters to be acquired becomes large, a table for specifying the order becomes large and complicated, and it becomes difficult to assume a display item order depending on a state in advance. Accordingly, it is difficult to apply this technique to a machine tool having a large number of parameters relating to a machining process and a machining state.

### SUMMARY OF THE INVENTION

Accordingly, an object of the present invention is to provide a numerical controller which can perform menu display in an appropriate display order according to a machining process and a machining state.

In the present invention, a menu display order on a numerical controller is determined using machine learning to solve the above-described problems.

A numerical controller according to the present invention is configured to control a machine tool for machining a workpiece based on a program and has a function for performing menu display in which functions relating to the machining can be selected. The numerical controller includes a machine learning device that performs machine learning of a menu item display order in the menu display. Further, the machine learning device includes: a state observation unit that acquires state data including information indicating a machining state in the machining and information indicating a selected menu item; a state learning unit that creates a machine learning model for determining a menu item display order in the menu display based on the state data acquired by the state observation unit; a learning result storage unit that stores the machine learning model; and a menu display order determination unit that determines a menu item display order in the menu display based on the machine learning model and the state data.

The information indicating the machining state may include at least any of an operation mode in machining, information indicating whether machining is being performed or not, override values, information indicating whether a dry run is being performed or not, information indicating whether machine lock is activated or not, information indicating whether single block is activated or not, information indicating whether air cut is being performed or not, information indicating whether a tool change is performed or not, a last-used function, and an alarm state, an alarm type, and an alarm number of the numerical controller and the machine tool.

Moreover, a machine learning device according to the present invention has performed machine learning of menu item display order in menu display performed by a numerical controller. In this case, the numerical controller is configured to control a machine tool for machining a workpiece based on a program and to perform menu display in a manner such that functions relating to the machining can be selected. Further, the machine learning device includes: a state observation unit that acquires state data including information indicating a machining state in the machining and information indicating a selected menu item; a learning result storage unit that stores a machine learning model obtained by performing machine learning of a menu item display order in the menu display; and a menu display order determination unit that determines a menu item display order in the menu display based on the machine learning model and the state data.

According to the present invention, an optimal menu can be realized on a machine tool, and an operator of the machine tool can easily select an application which the operator wants to use, in accordance with a machining process and a machining state.

### BRIEF DESCRIPTION OF THE DRAWINGS

The forgoing and other objects and feature of the invention will be apparent from the following description of preferred embodiments of the invention with reference to the accompanying drawings, in which:

FIG. 1A is a view for explaining an outline of the learning stage operation of a machine learning device for performing supervised learning;

FIG. 1B is a view for explaining an outline of the prediction stage operation of a machine learning device for performing supervised learning;

FIG. 2 is a schematic configuration diagram of a numerical controller according to an embodiment of the present invention;

FIG. 3 is a view showing an example of menu display performed by the numerical controller (machine learning device) in FIG. 2;

FIG. 4 is a flowchart showing the flow of a process from menu display to menu selection performed by the numerical controller (machine learning device) in FIG. 2; and

FIG. 5 is a flowchart showing the flow of a process for finding a machine learning model performed by the numerical controller (machine learning device) in FIG. 2.

### DETAILED DESCRIPTION OF THE PREFERRED EMBODIMENT

In the present invention, machine learning is performed using state variables indicated by a machining process, a machining state, and the like at the time of the machining of a workpiece by a machine tool and menu selection actions by a user to perform menu display in an appropriate display order according to the machining process and the machining state.

Hereinafter, machine learning introduced into the present invention will be briefly described.

### 1. Machine Learning

Generally, machine learning is categorized into various algorithms, such as supervised learning, unsupervised learning, and reinforcement learning, in accordance with objects and conditions. The present invention is aimed at learning correlations between states indicated by a machining process and a machining state at the time of the machining of a workpiece by a machine tool and menu selection actions by a user, and employs a supervised learning algorithm in consideration of capability of performance of learning based on explicit data, necessity of determining an appropriate menu item display order based on a learning result, and the like.

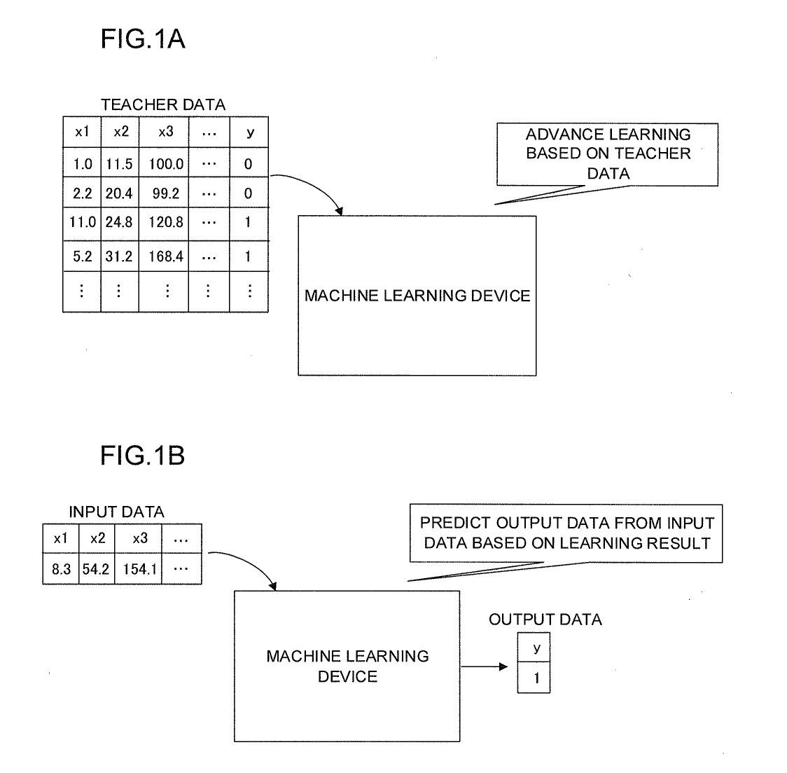

An outline of the operation of a machine learning device for performing supervised learning will be described with reference to FIGS. 1A and 1B.

The operation of the machine learning device for performing supervised learning can be broadly divided into two stages: a learning stage and a prediction stage. In the learning stage (FIG. 1A), when teacher data including values of state variables (explanatory variables) used as input data and values of an objective variable used as output data are given, the machine learning device for performing supervised learning learns to output a value of the objective variable upon receipt of values of the state variables. By giving several pieces of such teacher data, a prediction model for outputting a value of the objective variable for values of the state variables is built.

In the prediction stage (FIG. 1B), when new input data (state variables) are given, the machine learning device for performing supervised learning predicts and outputs output data (objective variable) according to a learning result (built prediction model).

In one example of learning by the machine learning device for performing supervised learning, for example, a regression expression for a prediction model such as represented by the following expression (1) is set. Learning is advanced by adjusting values of coefficients a₀, a₁, a₂, a₃, . . . so that values of the objective variable y may be obtained when values taken by the state variables x₁, x₂, x₃, . . . are substituted into the regression expression in the course of learning.

y=a₀+a₁x₁+a₂x₂+a₃x₃+ . . . +aₙxₙ (1)

In another example of learning by the machine learning device for performing supervised learning, for example, in a logistic regression model such as represented by the following expression (2) for the case where the probability that the value of the objective variable y is 1 is p, learning is advanced by adjusting values of coefficients a₀, a₁, a₂, a₃, . . . so that the probability p that the value of the objective variable y is 1 may be obtained when values taken by the state variables x₁, x₂, x₃, . . . are substituted into the regression expression in the course of learning. Thus, the probability that the objective variable y is 1 for values taken by the state variables can be predicted by the following expression (3). It should be noted that a learning method is not limited to these, and different learning methods are used for different supervised learning algorithms.

$$\begin{matrix}log ( \frac{p}{1 - p} ) = {a}_{0} + {a}_{1} {x}_{1} + {a}_{2} {x}_{2} + {a}_{3} {x}_{3} + … + {a}_{n} {x}_{n} & ( 2 ) \\ p = \frac{1}{1 + {e}^{- ( {a}_{0} + {a}_{1} {x}_{1} + {a}_{2} {x}_{2} + {a}_{3} {x}_{3} + … + {a}_{n} {x}_{n} )}} & ( 3 )\end{matrix}$$

As still another example of learning by the machine learning device for performing supervised learning, a technique is publicly known in which a support vector machine is used to learn multi-class classification based on values taken by state variables by machine learning (for example, “Ting-Fan Wu, Chih-Jen Lin, Ruby C. Weng, “Probability Estimates for Multi-class Classification by Pairwise Coupling”, Journal of Machine Learning Research, Vol. 5, pp. 975-1005, 2003.” and the like). Using such a publicly known technique, the probability that a given state belongs to each class can be calculated.

It should be noted that as supervised learning algorithms, various techniques other than the above-described techniques using logistic regression and a support vector machine are well known, including decision trees, neural networks, naïve Bayes classification, and the like. As a method which is applied to the present invention, any supervised learning algorithm may be employed. It should be noted that since these supervised learning algorithms are well known, detailed description of each algorithm is omitted in the present specification.

Hereinafter, a menu device of the present invention into which a machine learning device for performing supervised learning is introduced will be described based on a specific embodiment.

### 2. Embodiment

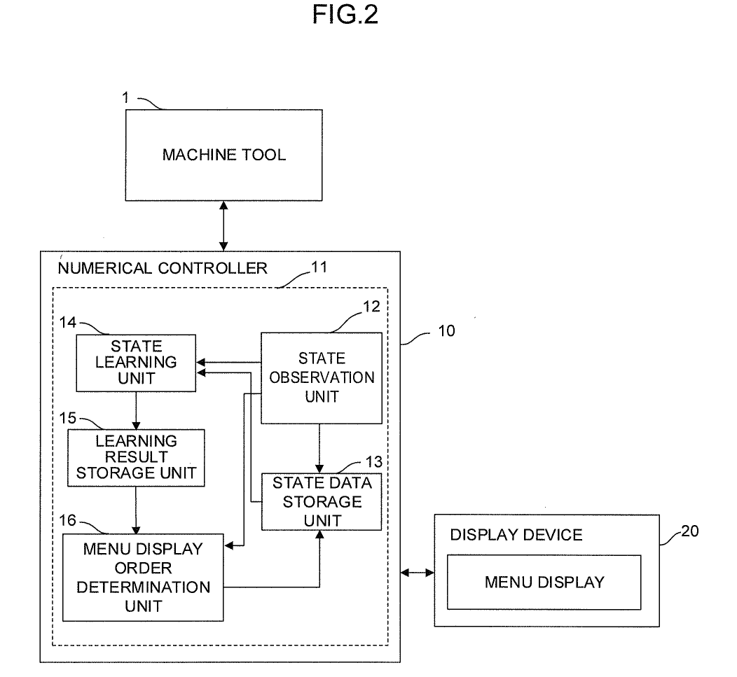

The configuration of a numerical controller in one embodiment of the present invention will be described with reference to FIG. 2.

A numerical controller 10 analyzes a program read from memory (not shown), and controls a machine tool 1 based on control data obtained as a result of the analysis, thus machining a workpiece. The machine tool 1 includes components (not shown) such as sensors for detecting information related to machining state at the time of machining. The numerical controller 10 is configured to be capable of acquiring information related to machining state through these components.

The numerical controller 10 includes a supervised machine learning device 11 (surrounded by a dotted line in FIG. 2). Moreover, a display device 20 is connected to the numerical controller 10. The display device 20 displays a menu for selecting a function of the numerical controller 10 to a user, and receives menu selection from the user. It should be noted that with regard to the numerical controller 10 in FIG. 2, components except components particularly required for an explanation of machine learning operation in the present invention will not be described in detail.

A state observation unit 12 of the supervised machine learning device 11 acquires information relating to a machining state, occurrence of malfunction, and the like acquired from the machine tool 1 and information indicating a machining state acquired from the numerical controller 10. Data concerning a machining state could include the following:

[Data Concerning Debugging Runs/Continuous Runs]

A mode of operation, information indicating whether machining operation is being performed or not, override values, information indicating whether a dry run is being performed or not, information indicating whether machine lock is activated or not, information indicating whether single block is activated or not, information indicating whether air cut is being performed or not, information indicating whether a tool change is performed or not, and the like

[Data Concerning Manipulation]

A menu item selected by the user, a last-used function, and the like

[Data Concerning Anomalies]

Alarm state, alarm type, and alarm number of the numerical controller/the machine tool, and the like

A state data storage unit 13 stores state data acquired by the state observation unit 12 and data relating to a menu display order determined by an after-mentioned menu display order determination unit 16, and outputs the state data and the data relating to the menu display order which have been stored thereon, in response to a request from the outside. With regard to state data stored in the state data storage unit 13, pieces of state data generated by one menu selection operation are stored as a set of pieces of data.

A state learning unit 14, a learning result storage unit 15, and the menu display order determination unit 16 constitute a major part of the supervised machine learning device.

The state learning unit 14 performs supervised learning based on the state data acquired by the state observation unit 12 and the state data stored in the state data storage unit 13, and stores a result of the learning on the learning result storage unit 15. The state learning unit 14 advances supervised learning using teacher data in which among pieces of the state data, a menu item selected by the user is set as an objective variable, and other pieces of the state data are set as state variables. In one example of learning, a regression model is used as a prediction model. In this case, a regression model may be prepared for each of menu items corresponding to functions of the numerical controller 10, and the probability that the menu item is selected for a machining state indicated by the state variables may be learned. Moreover, in the case where a support vector machine, a neural network, a decision tree, naïve Bayes classification, or the like is used, a classifier may be similarly prepared for each of menu items corresponding to functions of the numerical controller 10. Alternatively, a model may be used which performs multi-class classification that classifies a machining state indicated by the state variables into any of a plurality of menu items.

The learning result storage unit 15 stores a result of learning performed based on the teacher data by the state learning unit 14, and outputs the stored learning result in response to a request from the outside. The learning result stored in the learning result storage unit 15 can also be applied to other malfunction diagnosis apparatus or the like.

When a menu is displayed on the display device 20, the menu display order determination unit 16 determines a menu item display order based on the state data on the machine tool 1 and the numerical controller 10 which are acquired by the state observation unit 12, using the learning result stored in the learning result storage unit 15.

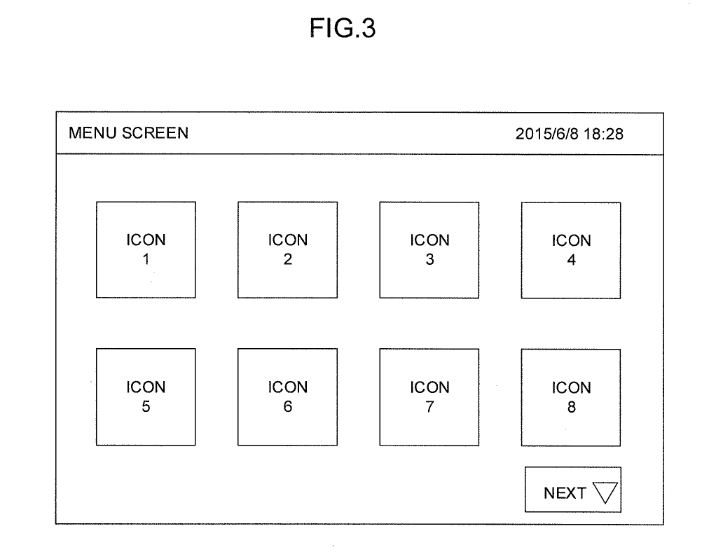

When a menu item display order is determined, the probability that each menu item is selected is found based on the learning result stored in the learning result storage unit 15 and the state data acquired by the state observation unit 12, and menu items may be displayed from the menu item for which the found probability is highest such that the menu item is displayed at a position where the user can select the menu item easier. For example, in the case of menu display in which a plurality of menu items are displayed as icons as shown in FIG. 3, when a menu item display order is determined, icons may be arranged from top left in descending order of the probability of selecting each menu item calculated based on the current state data. Moreover, in the case where menu display is divided into categories, menu items may be arranged in order in each category.

Then, a menu is displayed on the display device 20 in the menu item display order determined by the menu display order determination unit 16.

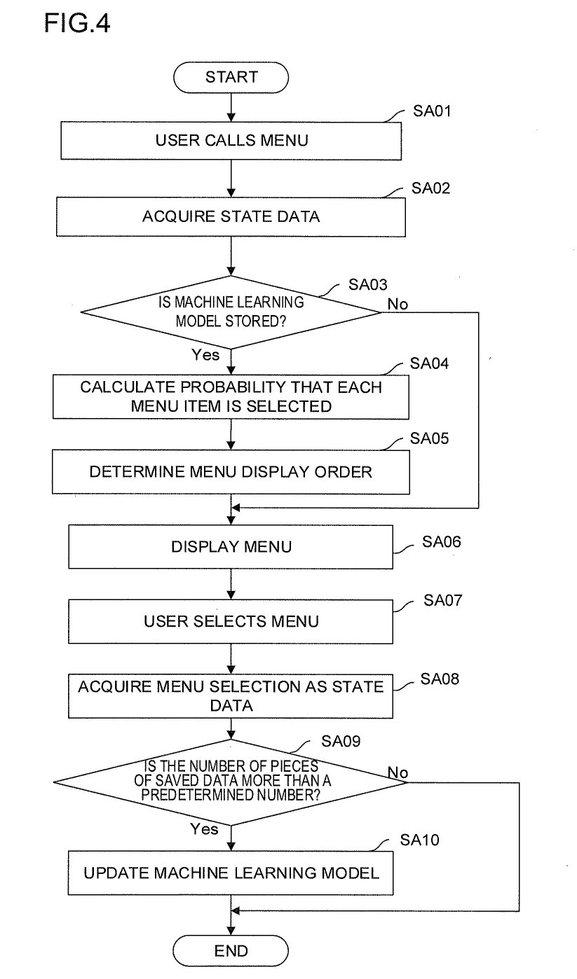

The flow of a process from menu display to menu selection performed by the machine learning device 11 of the numerical controller 10 will be described with reference to a flowchart in FIG. 4. The processing is explained below according to respective steps.

[Step SA01] A user presses a menu button displayed on a screen of the numerical controller or attached to the machine to call a menu.

[Step SA02] The state observation unit 12 acquires state data indicating a machining state on the machine tool 1 and the numerical controller 10.

[Step SA03] A determination is made as to whether a “machine learning model” obtained by learning a menu item display order is stored in the learning result storage unit 15 or not (learned or not). If the machine learning model is stored, the process proceeds to step SA04. If the machine learning model is not stored, the process proceeds to step SA06.

[Step SA04] The menu display order determination unit 16 finds the probability that each menu item is selected, based on the state data acquired in step SA02, using the “machine learning model” stored in the learning result storage unit 15.

[Step SA05] The menu display order determination unit 16 determines a menu display order based on the probability that each menu item is selected, the probability being found in step SA04.

[Step SA06] A menu is displayed on a screen of the display device 20 in the display order determined in step SA05 if a “machine learning model” is stored in the learning result storage unit 15, or in a predetermined display order specified in advance if a “machine learning model” is not stored thereon.

[Step SA07] The user selects any of the menu items from the menu display.

[Step SA08] The state observation unit 12 acquires the menu item selected in step SA07 by the user as state data, and stores the menu item on the state data storage unit 13 in association with the state data acquired in step SA02.

[Step SA09] A determination is made as to whether a set of pieces of state data stored in the state data storage unit 13 are more than the minimum number of pieces of data needed to find a predetermined “machine learning model” or not. If the set of pieces of state data is more than the minimum number of pieces of data, the process proceeds to step SA10, and, if the set of pieces of state data is less than the minimum number of pieces of data, this process is ended.

[Step SA10] An expression of the machine learning model is updated (created) based on the state data stored in the state data storage unit 13 and the updated expression is stored in the learning result storage unit 15.

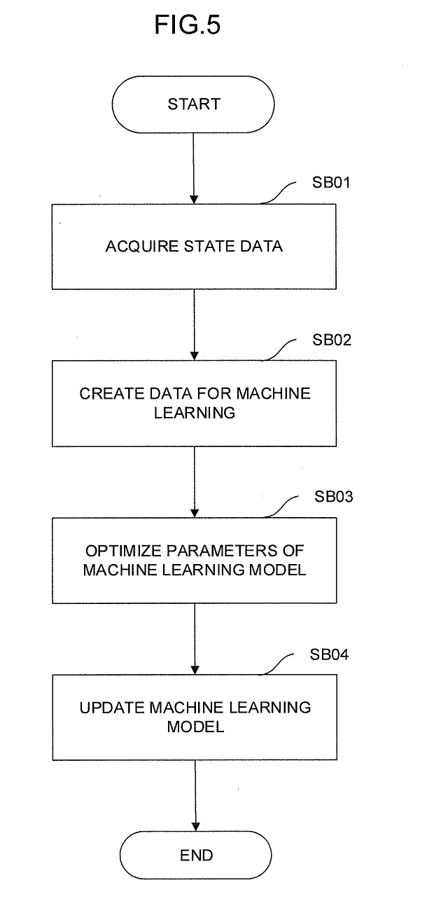

The flow of a process for finding a machine learning model which is performed by the machine learning device 11 of the numerical controller 10 will be described with reference to a flowchart in FIG. 5.

[Step SB01] The state learning unit 14 acquires a set of data indicating a machining state stored in the state data storage unit 13 and data on a selected menu item. The number of pieces of data acquired is specified in advance to be the minimum number of pieces of data needed to create a model. If the number of pieces of data saved is more than the maximum number of pieces of data, pieces of data having newest saved dates, the number of which equals to the maximum number of pieces of data, are used.

[Step SB02] The state learning unit 14 creates data for machine learning by applying a process for converting non-numeric data into a predetermined numeric value, a process for normalizing data, and the like so that a machine learning model can calculate each value of the acquired data.

[Step SB03] Using the data for machine learning created in step SB02, parameters of a machine learning model are optimized. With regard to an optimization technique, a technique suitable for a machine learning algorithm employed is used.

[Step SB04] The machine learning model created in step SB03 is stored (updated) in the learning result storage unit 15.

It should be noted that the machine learning device 11 may be detachably attached to the numerical controller 10. Moreover, a learning result stored in the learning result storage unit 15 of the machine learning device 11 which has completed learning and state data stored in the state data storage unit 13 thereof can also be taken out and stored in other machine learning devices to produce a large number of machine learning devices which have completed learning.

While an embodiment of the present invention has been described above, the present invention is not limited only to the above-described examples of the embodiment, but can be carried out in various aspects by making appropriate modifications thereto.

1. A numerical controller for controlling a machine tool for machining a workpiece based on a program, wherein
the numerical controller has a function for performing menu display in which functions relating to the machining can be selected, and
the numerical controller comprises a machine learning device that performs machine learning of a menu item display order in the menu display, and wherein
the machine learning device includes
a state observation unit that acquires state data including information indicating a machining state in the machining and information indicating a selected menu item,
a state learning unit that creates a machine learning model for determining a menu item display order in the menu display based on the state data acquired by the state observation unit,
a learning result storage unit that stores the machine learning model, and
a menu display order determination unit that determines a menu item display order in the menu display based on the machine learning model and the state data.

2. The numerical controller according to claim 1, wherein
the information indicating the machining state includes at least any of an operation mode in machining, information indicating whether machining is being performed or not, override values, information indicating whether a dry run is being performed or not, information indicating whether machine lock is activated or not, information indicating whether single block is activated or not, information indicating whether air cut is being performed or not, information indicating whether a tool change is performed or not, a last-used function, and an alarm state, an alarm type, and an alarm number of the numerical controller and the machine tool.

3. A machine learning device in which machine learning of menu item display order in menu display by a numerical controller has been carried out, wherein
the numerical controller is configured to control a machine tool for machining a workpiece based on a program and to perform menu display in a manner such that functions relating to the machining can be selected, and
the machine learning device includes
a state observation unit that acquires state data including information indicating a machining state in the machining and information indicating a selected menu item,
a learning result storage unit that stores a machine learning model obtained by performing machine learning of a menu item display order in the menu display, and
a menu display order determination unit that determines a menu item display order in the menu display based on the machine learning model and the state data.
